(19) United States
(12) Patent Application Publication
(10) Pub. No.: US 2022/0224116 A1
(43) Pub. Date: Jul. 14, 2022

(54) METHOD OF CONTROLLING NEGATIVE AND ZERO SEQUENCE COUPLING OF OVERHEAD POWER LINE

(71) Applicant: Robert John Nelson, Orlando, FL (US)

(72) Inventor: Robert John Nelson, Orlando, FL (US)

(21) Appl. No.: 17/145,119

(22) Filed: Jan. 8, 2021

(51) Int. Cl. H02J 3/20

(52) U.S. Cl. CPC H02J 3/20

(57) ABSTRACT

This invention describes a means of statically controlling the negative and zero sequence couplings of an overhead line with unequal spacing between phases and describes a means of controlling either the negative sequence coupling or the zero sequence coupling, which may be advantageous for some power system applications. In particular, this invention describes a means of reducing either the negative sequence coupling or the zero sequence coupling to a value approaching zero, thereby reducing the negative sequence or zero sequence induced voltage resulting from balanced current flows.

This application claims the benefit of a provisional patent Application No. 62/958,924, Confirmation Number 4963, filed 2020 Jan. 9 by the present inventor.

### FIELD OF THE INVENTION

The present invention relates in general to the field of overhead power lines, and more particularly, to the method of controlling the unbalanced voltages resulting from the flow of balanced currents in the lines. The invention has particular application for power lines that connect renewable and synchronous generation power sources to the power system.

### BACKGROUND OF THE INVENTION

### Prior Art

The following is a tabulation of some prior art that appears relevant:

### U.S. PATENTS

| Patent Number | Issue Date | Patentee |
|---|---|---|
| 5,198,746 | Mar. 30, 1993 | Gyugyi, et al. |
| 6,486,569 | Nov. 26, 2002 | Couture |
| 8,816,527 | Aug. 26, 2014 | Ramsay, et al. |
| 9,172,246 | Oct. 27, 2015 | Ramsay, et al. |
| 9,500,182 | Nov. 22, 2016 | Zagrodnik |
| 10063174 | Aug. 28, 2018 | Larsen, et al. |

### Non-Patent Literature

Analysis of Faulted Power Systems (book) by PAUL ANDERSON, Iowa State University Press, 1973
International Electrotechnical Commission 61400-1:2019, “Wind energy generation systems—Part 1: Design requirements”
Institute of Electrical and Electronic Engineers C50.13-2014, “IEEE Standard for Cylindrical-Rotor 50 Hz and 60 Hz Synchronous Generators Rated 10 MVA and Above”

There have been a number of solutions proposed for the treatment of unbalanced operation of power lines. Notably, Gyugyi, et al proposed a power electronic solution in U.S. Pat. No. 5,198,746, whereby a power electronic circuit could inject a simulated impedance of the correct type to correct a dynamic unbalance. Couture proposed a serial impedance modulator in U.S. Pat. No. 6,486,569 to insert impedances electronically into a power transmission line. Ramsay, et al, proposed a scheme that used switching protocols to vary phase currents to attain balanced operation in U.S. Pat. No. 8,816,527 and with some modifications in U.S. Pat. No. 9,172,246. The common factor in all of these solutions is the use of rapid controls to determine the extent of the unbalance and subsequent control actions based upon system measurements. All require sophisticated controls and, typically, power electronic, electromagnetic, or switching assemblies for means for fast and responsive response. All of the solutions implicitly assume the use of identical phase conductors for the 3 phases of a typical power line. All are dynamic solutions.

Zagrodnik et al proposed a method for controlling unbalance in a wind turbine via a selection from several induction compensation devices in a wind turbine, based on local measurements in U.S. Pat. No. 9,500,182. Larsen, et al. addressed the issue of negative sequence current in a wind turbine generator using a wind turbine negative sequence electronic current regulator in U.S. Ser. No. 10/063,174 using electronically controlled power converters that respond measured levels of negative sequence current at the turbine's bus. Both of these are dynamic controls that are intended to protect the wind turbine from excessive phase unbalance in the power system. Neither addresses a root cause of the problem—namely the negative sequence coupling of power lines.

Notation in this patent application generally follows that of “Analysis of Faulted Power Systems”, cited above.

### SUMMARY

Methods recently developed to suppress the effects of phase unbalance in the power system are defensive. They attempt to reduce the phase unbalance by rapid measurements, controls and various means of inserting reactive devices, synthesized impedances, current or voltage control. This patent application describes a static solution to the problem of phase unbalance that reduces the need for dynamic balancing methods described in recent patent activity.

### Advantages

The method described in this patent is a static solution to the concern of unbalance. Specifically, the method described can be used to reduce either the negative or zero sequence unbalance in the power system by suitable selection of phase conductors or phase conductor arrangements. There is no need for sophisticated controls or power electronics and their associated losses, expense, and need for maintenance.

### DRAWINGS

FIG. 1 shows a representative three phase power line with identical conductor arrangements (bundled conductors with 2 conductors per bundle) in all 3 phases. The phases are in a typical linear (flat) configuration, with the outside phases equidistant from the center phase, so that the distance from outside phase to outside phase is twice the distance from an outside phase to the center phase.

FIG. 2 shows the line of FIG. 1 with the bundled conductor in the center phase replaced with a single conductor to reduce the negative sequence coupling of the line as explained in the Detailed Description.

### DETAILED DESCRIPTION

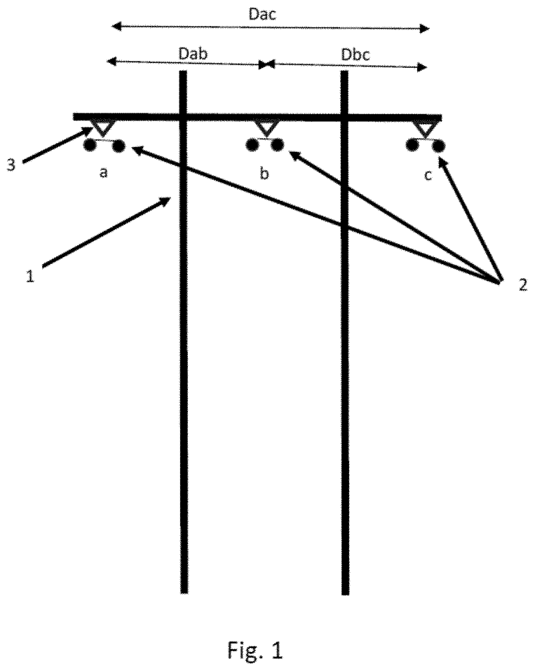

Both renewable and synchronous generating plants are connected to the power system via 3-phase power lines. The power lines are comprised of 3 phases that ideally are excited by three phase voltages of equal magnitude, but 120 electrical degrees out of phase with each other, ideally carrying currents equal in magnitude and 120 electrical degrees out of phase with each other. The relationships between the current flows and the voltage drops in the lines are principally described by the line's impedances, which consist of a self impedance, associated with the resistance and geometry of the conductors in each phase, and with a mutual impedance, associated with the geometry of the phases with respect to each other. It has been the customary practice to use identical conductors or conductor arrangements in all 3 phases, so self-impedances are always identical. It is often the case that the mutual impedances are different because the mutual impedances are a function of the spacing between the phases. In FIG. 1, the power lines are supported by line structures 1 and hung from insulators 3. There are 3 phase conductors 2, designated a, b, and c, with phases a and c occupying the outside position and phase b in the center. All phases have identical conductors. In this case, they are shown as having 2 conductors per phase in a so-called “2-bundled conductor” arrangement. It is possible that the phases could be comprised of 1 or more conductors. Because the phase conductors are identical, the self impedances of the 3 phases are identical. But the mutual impedances are not identical. In particular, the distances from the center phase (b) to the other phases (D_{ab} and D_{bc}) may be the same, but the distances of the outside phases to the remaining phases (D_{ac} and D_{ab} for phase a and D_{ac} and D_{bc} for phase b) are different. As a consequence, for a given identical positive sequence current flow in each of the three phases, the voltage drop in phase b is different than the voltage drop in phases a and c. This results in unbalanced operation of the power line, with unequal voltages in the 3 phases.

It is possible to design power lines so that the distances between the phases is equal, but there are a number of reasons why this is not typically done, including cost and constraints on the design of the power lines. Many lines have height constraints or width constraints, so it becomes necessary to design them either in a flat horizontal configuration, as shown in FIG. 1 or, where width-constrained (as sometimes occurs on a narrow right-of-way) a flat vertical configuration, with conductors in a linear vertical arrangement. In either a horizontal or vertical arrangement, there will normally be a difference in the voltage drops of the 3 phases associated with the use of equal self-impedances and differing mutual impedances.

The different phase mutual impedances result in induced negative sequence voltages and zero sequence voltages in the lines for balanced current flow through the lines. This often described as “voltage unbalance”. Zero sequence voltages can be a concern because they can increase losses and cause measurement errors, but the methods of dealing with zero sequence voltages are well known and it is possible to control the impact of induced zero sequence voltages via the use of grounding techniques and transformer designs, as is well understood by those familiar with power system design. Negative sequence voltages are not a concern for static equipment, but can cause damage to rotating machines, which typically present a very low impedance to negative sequence voltages. Damage includes overheating of rotors, double-frequency torques that can produce high-cycle fatigue, and increased winding losses. Some machinery design standards (e.g., IEC 61400-1, which is used to design wind turbines, and IEEE C50.13, which is used to design synchronous generators) place explicit limits on either negative sequence voltages or induced negative sequence currents resulting from system negative sequence voltages. It is generally held that the limits used in the wind turbine standards, which limit operation to systems with less than 2% negative sequence voltage, is an acceptable safe level, though even this may be excessive for certain synchronous machine connections.

Despite the fact that power lines create negative sequence voltages during normal operation, system negative sequence voltages are limited, to a large extent, by the presence of machinery, and especially synchronous generators, on the power system. Synchronous generators present a low impedance to negative sequence voltage and can circulate negative sequence currents. But, increasingly, synchronous generators are being displaced by converter-based generation. Converters typically present very high impedance to negative sequence. Many converters generate only positive sequence currents. When positive sequence currents flow on a line with unequal phase impedances, negative sequence voltages are induced.

The factor that relates the induced negative sequence voltage resulting from the flow of the positive sequence current through the line is sometimes called the negative sequence “coupling factor”. There is also a zero sequence “coupling factor” that relates the zero sequence voltage induced from positive sequence (balanced) current flows in the phases.

It can be shown that the negative sequence voltage induced in a relatively short line can exceed acceptable limits. In a 50-mile line with a linear conductor configuration, like that shown in FIG. 1, with equal conductor spacing from the outside phases to the center phase that has an ampacity of 2000 A/phase, for example, a typical negative sequence coupling parameter is 0.049+j0.028 Ohms/mi. The negative sequence voltage induced in the line is almost 10 kV, line-line, at rated current. This corresponds to a negative sequence voltage of roughly 4% for a 230 kV line and 7% for a 138 kV line, both of which are generally unacceptable values for lines connected to some synchronous generators or wind plants, which typically must have negative sequence voltages less than 2% for continuous operation.

In some power systems, it is traditional to use phase transposition to minimize the negative and zero sequence coupling factors. In phase transposition, the phase locations are interchanged. A completely transposed transmission line, for example, would have phase a in the center position for ⅓ of the length of the line, phase b in the center for another ⅓, and phase c in the center for another ⅓. This can be accomplished either with transposition towers, where the phases are physically re-arranged, or by transposing at switching stations, if available. This practice continues, but many transmission designers prefer to avoid transposition towers because they are expensive, they require additional height or width in right-of-way, and they present additional failure risk, since they are unique designs. Transposition at switching stations depends on the availability of switching stations. A 50-mile long line that connects a generating plant to the power grid will typically have no switching stations, except at the interconnection point, which is not necessarily owned by the owner of the interconnecting line. As a result, it may be quite difficult or expensive to reduce negative and zero sequence coupling by transposition for many lines used to interconnect generation sources that may be located some distance from the power grid.

Most attempts to control negative and zero sequence voltages without the use of transposition, a topic that comes under the general description of power system unbalanced operation, have either consisted of special switching arrangements or defensive measures used by power generation equipment. None, other than transposition, have addressed this root cause of the issue.

Like transposition, the method described here does not require any controls at all. Like transposition, it is a static solution to the unbalance problem. Unlike transposition, it requires no special towers or station design complexities. This method proposes a novel solution of compensating for inequalities of the mutual impedances by adjusting one or more the phase self-impedances in the line via selection of phase conductors. By using different conductors or conductor geometries in the 3 phases of a power line, it is possible to reduce or eliminate the negative or zero sequence voltage induced by normal (positive sequence) current flows without the use of transposition. This invention is not a dynamic solution, as described in the prior art. It is a fixed, steady-state solution to a problem that is encountered by generating plants interconnecting with power systems.

The negative sequence coupling factor can be reduced, in many cases to zero, by using different conductors or conductor arrangements in the 3 phases to compensate for the unequal mutual impedances. Generally, this requires an increase in the self-impedance of the center phase relative to the outer phases. It is also possible to reduce the zero sequence coupling factor, but this generally requires a reduction in the self-impedance of the center phase relative to the outer phases.

This invention is a method of controlling the negative and zero sequence coupling of a power line with phase spacing that is not identical for all 3 phases without the use of transposition or dynamic controls.

Either the negative sequence coupling factor, which determines the negative sequence voltage drop of a power line for positive sequence current flows, or the zero sequence coupling factor, which determines the zero sequence voltage drop for positive sequence current flows, can be adjusted to a desired value, including zero.

### Preferred Embodiment

It has been customary to use the same conductor or conductor configuration in all 3 power-carrying phases of an overhead power line, despite the fact that the impedances of the three phases may be different because of their geometries.

For example, it will often be the case that the phases are spaced equally from the adjacent phase in a linear arrangement. Assuming that the outside phases are phases a and c, this means that D_{ac} (the distance between phases a and c) is twice the distances D_{ab} or D_{bc}, as shown in FIG. 1.

The general expressions for the self and mutual impedances, in Ohms per unit length, are Self impedance of phase “m”: Zₘₘ=(rₘ+r_{d})+jωk ln (Dₑ/GMRₘ)

Where: rm is the resistance of the phase conductor(s) per unit length,
r_{d} is the resistance of the earth return per unit length,
j is the square root of (−1) (imaginary operator)
ω is the angular frequency in radians/sec (377 for 60 Hz, 314 for 50 Hz)
Dₑ is a parameter that is a function of the local soil electrical resistivity
GMRₘ is a parameter that describes the geometry of the phase conductors; it is sometimes called the “Geometric Mean Radius” of phase m
K is a proportionality constant

The parameters rₘ and GMRₘ are functions of the phase conductors for phase m. The other parameters are generally considered to be constants for a given line and system. Obviously, use of the same conductor arrangements in the 3 phases, as has been the universal practice, ensures that the self impedances of all 3 phases are identical.

Mutual impedance between phases “m” and “n”: Zₘₙ=r_{d}+jωk ln (Dₑ/Dₘₙ)

Where Dₘₙ is the physical center-to-center distance between phases m and n.

Clearly, a larger physical distance, Dₘₙ, corresponds to a smaller mutual impedance.

With these relationships, it is possible to describe the voltage drops in a transmission line due to current flow through the resistance and reactances of the conductors:

$$\begin{matrix}Va \\ Vb \\ Vc\end{matrix} = \begin{matrix}{Z}_{aa} & {Z}_{ab} & {Z}_{a c} \\ {Z}_{ab} & {Z}_{bb} & {Z}_{ab} \\ {Z}_{a c} & {Z}_{ab} & {Z}_{cc}\end{matrix} \times \begin{matrix}Ia \\ Ib \\ Ic\end{matrix} \qquad Equation 1$$

Where Va, Vb, and Vc are the voltage drops in phases a, b, and c, respectively, and Ia, Ib, and Ic are current flow in those phases. These voltages, currents, and impedances have both a magnitude and a phase and are customarily portrayed as phasors.

To evaluate the coupling factors, the impedance matrix may be transformed into the “symmetrical component” impedance matrix via the symmetrical component transformation and to convert the impedance matrix into the symmetrical component impedance matrix.

The symmetrical component transformation of the impedances of single circuit 3-phase power line is shown below in matrix format (notation used is consistent with “Analysis of Faulted Power Systems”, 1971, by P. Anderson, Iowa State University Press).

$$\vert {Z}_{012} \vert = 1 / 3 \times \vert {A}^{- 1} \vert \times \vert {Z}_{abc} \vert \times \vert A \vert : \begin{matrix}{Z}_{00} & {Z}_{01} & {Z}_{02} \\ {Z}_{`10} & {Z}_{11} & {Z}_{12} \\ {Z}_{20} & {Z}_{21} & {Z}_{22}\end{matrix} = 1 / 3 \times \begin{matrix}1 & 1 & 1 \\ a & a & {a}^{2} \\ 1 & {a}^{2} & a\end{matrix} \times \begin{matrix}{Z}_{aa} & {Z}_{ab} & {Z}_{a c} \\ {Z}_{ab} & {Z}_{bb} & {Z}_{ab} \\ {Z}_{ a c} & {Z}_{ab} & {Z}_{cc}\end{matrix} \times \begin{matrix}1 & 1 & 1 \\ 1 & {a}^{2} & a \\ 1 & a & {a}^{2}\end{matrix} \qquad Equation 2$$

Where:
   |Z₀₁₂|=Line sequence impedance matrix
   |Z_{abc}|=Line self- and mutual-impedance matrix
   |A| and —1A⁻¹|=symmetrical component transformation matrix and its inverse
a=−0.5+j0.866 (complex number)
a²=−0.5−j0.866 (complex number)
j=√(−1)(imaginary number)

Two parameters in the symmetrical component impedance matrix are of particular significance for this invention. Specifically, Z₂₁ relates the negative sequence voltage caused by a positive sequence current flow and Z₀₁ relates the zero sequence voltage caused by a positive sequence current flow.

Carrying out the indicated operations, it can be shown that

Z₂₁=⅓{(Zₐₐ+a Z_{bb}a²Z_{cc})+2(a²Z_{ab}+Z_{bc}+a Z_{ac})} Equation 3

This is a general expression for parameter Z₂₁ of a 3-phase power line.

If the lines are equidistant, Z_{ab}=Z_{bc}=Z_{ac} and the term (a² Z_{ab}+Z_{bc}+a Z_{ac}) goes to zero.

If identical conductors are used in all 3 phases, Zₐₐ=Z_{bb}=Z_{cc} and the term (Zₐₐ+a Z_{bb} a² Z_{cc}) goes to zero. So a line with equidistant phase spacing and identical conductors has Z₂₁=0 and, consequently, has no negative sequence coupling.

For the more common case of identical conductor arrangements in each phase but non-equidistant spacing, Z₂₁ is non-zero:

Z₂₁=⅔(a²Z_{ab}+Z_{bc}+a Z_{ac}) Equation 4

and a negative sequence voltage proportional to the product of Z21 and I1 will be induced in the line by the flow of positive sequence currents.

Using (Equation 3) and setting Z21 to zero,

Zₐₐ+a Z_{bb}+a²Z_{cc}=−2*(a²Z_{ab}+Z_{bc}+a Z_{ac}) Equation 5

This is the general condition for Z21=0 for a 3-phase line.

For the typical case that D_{ac}=2 D_{ab}=2 D_{bc}, so that Z_{ab}=Z_{bc}, but Z_{ac} has a different value, this becomes:

Zₐₐ+a Z_{bb}+a²Z_{cc}=2*(a Z_{ab}−a Z_{ac}) Equation 6

For the horizontal linear configuration, such as shown in FIG. 1, it is advantageous, mechanically, for the outside conductors to have equal weight, so the preferred embodiment is that Zₐₐ=Z_{cc}, so the requirement for Z₂₁=0 becomes

Z_{bb}=Zₐₐ+2*(Z_{ab}−Z_{ac}) Equation 7

This presents a very useful result. It is possible to eliminate the negative sequence coupling factor (Z₂₁) of the overhead three-phase line by simply increasing the self-impedance of the center phase by an amount equal to 2*(Z_{ab}−Z_{ac}) compared to the outer phases. So, for example, if Zₐₐ is 5+j 25 Ohms per phase and (Z_{ab}−Z_{ac}) is 2.25+j 1.4 Ohms per phase, Z₂₁ will approach zero if Z_{bb} is selected to be 7.25+j26.4 Ohms per phase and Z₂₁ will be reduced from the equal conductor case for any value of Z_{bb} between 5+j25 and 7.25+j 26.4 Ohms per phase. It is also possible to reduce the self-impedances of the outer phases by the same amount to attain this result, i.e., Zₐₐ=Z_{cc}=Zₐₐ−2*(Z_{ab}−Z_{ac}) results in Z₂₁ going to zero.

As a practical matter, it may not be necessary to completely eliminate the negative sequence coupling. In many cases, it can simply be reduced. For example, any value of Z_{bb} between Zₐₐ and (Zₐₐ+2 (Z_{ab}−Z_{ac})) results in a reduction in the negative sequence coupling. A value higher than Zₐₐ+2 (Z_{ab}−Z_{ac}) results in an increase in the negative sequence coupling from the zero point.

There are several ways to adjust the self impedances of the center or outside phases, as are well-understood by those familiar with the art of transmission line design. One theoretical way to increase the self impedance of the center phase is to introduce a series impedance into the phase by using a fixed single phase reactor. It is also theoretically possible to reduce the self impedances of the outside phases by using two fixed single phase series capacitors in the outside phases. But these methods are expensive and may result in increased losses and reduced reliability. A more inexpensive tactic would be to use either different sized conductors or, most simply for the case that the phase conductors are bundled, to adjust the bundled conductors and/or bundle spacing, which are used to determine the phase GMR. Reducing the bundle spacing of a phase, everything else being equal, increases the self impedance. Reducing the bundle spacing in the center phase or increasing the bundle spacing in the outer phases results in a decrease in the negative sequence coupling, up to a point described by the equations shown above.

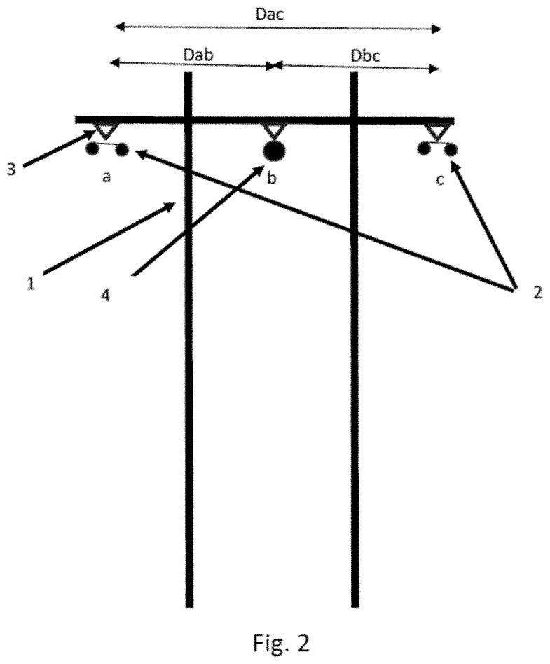

FIG. 2 shows the center 2-conductor bundle 4 from FIG. 1 replaced by a single conductor, sized to have the same or similar ampacity to the outside phase bundles. The single conductor would normally have a higher self-impedance than the outside bundles, as could readily be calculated by one familiar with transmission line design and could be optimized to reduce the negative sequence coupling of the line to a necessary value. It is also possible to use smaller bundle spacing in the center phase than the outside phases or to increase the bundle spacing of the outside phases relative to the center phase, all of which have the desired effect of increasing the self-impedance of the center phase.

It may be possible, in some cases, to attain the condition of Z₂₁₌₀ or to reduce the negative sequence coupling by simply adjusting the bundle spacing of phases using bundled conductors. If the phase resistance is the same in all phases (i.e., rₐ=r_{b}=r_{c}), some simple algebra reveals that Z₂₁ goes to zero when GMR_{b}=GMRₐ×(D_{ab}/D_{ac})².

Performing a similar set of calculations for the term (Z₀₁), that represents the coupling between the zero sequence voltage and the positive sequence current:

Z₀₁=⅓{(Zₐₐa²Z_{bb}+a Z_{cc})−(a Z_{ab}+Z_{bc}+a²Z_{ac})} Equation 8

And the general requirement for Z₀₁ to be zero is

Zₐₐa²Z_{bb}+a Z_{cc}=a Z_{ab}+Z_{bc}+a²Z_{ac} Equation 9

Again, assuming that D_{ac}=2 D_{ab}=2 D_{ac} and allowing the self impedance of the center phase to vary to reduce the coupling, Equation 8 becomes:

Z₀₁=a²/3(Z_{b}−Zₐ+Z_{ab}−Z_{ac}) Equation 10

Solving for the value of Z_{b} that results in a zero value of Z₀₁,

Z_{bb}=Zₐₐ−(Z_{ab}−Z_{ac}) Equation 11

The result is similar to that of Equation 7, but calls for a reduction of Z_{bb} to reduce the zero sequence coupling. Again, if the phase resistances are the same, some algebra reveals that this relationship is satisfied when GMR_{b}=GMRₐ×(D_{ac}/D_{ab}).

Referring again to FIG. 2, the zero sequence coupling could be reduced from FIG. 1 by replacing the outside bundles with single conductors and leaving the original 2-conductor bundle in the center so that Equation 11 is at least approximately observed in the new conductor arrangement.

An unfortunate aspect of this means of sequence impedance design is that adjustments made to decrease the negative sequence coupling have the effect of increasing the zero sequence coupling. In most cases, it is likely that the parameter of interest will be the negative sequence coupling and some increase in the zero sequence coupling can be tolerated, since the means of reinforcing the power system for high zero sequence voltage are well-known, while there are very few tools to combat the effects of high negative sequence voltage. However, it is possible that there may be some interest, in some cases, of reducing the zero sequence impedance at the expense of the negative sequence impedance. In some systems, negative sequence is of no concern and there may be a need to reduce the zero sequence coupling. The principles for controlling the two are the same.

### ALTERNATE EMBODIMENTS

Clearly, extensions to other configurations of overhead line are possible. It is not necessary that the conductors be in linear configuration or to have symmetry. Use of the principles outlined in this patent will allow a power line designer to adjust the negative and zero sequence couplings with positive sequence current flows without the use of transposition towers, transposing lines at switching stations, injecting synthesized impedances, inserting inductors or line sections, controlling current or voltage. It is a static, steady-state solution. It is easy for someone with knowledge of power line electrical design to design the various self impedances for any 3-phase line using the principles outlined in this patent, as will readily be understood by those familiar with the state of the art. Nor is it necessary that only one or two phases use different conductor arrangements. It is possible that all 3 phases could have different conductor arrangements and spacings. The exemplary manifestation of a line with equal spacing between the outside phases and the center phase was used in this patent application because it seems to be the most widely used. Extensions to other line configurations will be obvious to those familiar with transmission line electrical design.

What is claimed is:

1. A means of controlling the negative or zero sequence coupling with positive sequence currents by using conductors or conductor configurations with different self impedances in one or more phases of a 3-phase overhead power line.

2. The method of claim 1 by using different bundle spacing in a 3-phase bundled conductor line in one or more phases of a 3-phase overhead power line.

3. The method of claim 1 by using a single conductor in one or more phases and bundled conductors in the remaining phases of a 3-phase overhead power line.

4. The method of claim 1 by adding a static external impedance in one or more phases of a 3-phase overhead power line to adjust the design values of the negative or zero sequence impedances of a power line.

5. The method of claim 1 adding synthesized external impedances in one or more phases of a 3-phase overhead power line to adjust the effective values of the negative or zero sequence impedances of a power line.

6. A method of reducing the induced negative sequence voltage in a three phase overhead power line associated with the flow of positive sequence currents by varying the conductor and conductor arrangements in the 3 phases.

7. A method of reducing the induced zero sequence voltage in a three phase overhead power line associated with the flow of positive sequence currents by varying the conductor and conductor arrangements in the 3 phases
